(19) United States
(12) Patent Application Publication
(10) Pub. No.: US 2006/0195380 A1
(43) Pub. Date: Aug. 31, 2006

(54) Systemic investment data analysis

(75) Inventor: David Lloyd Walsh, Dublin (IE)

Correspondence Address: WATTS HOFFMANN CO., L.P.A., Suite 1750, 1100 Superior Avenue, Cleveland, OH, 44114-2518, US

(73) Assignee: BEACON SYSTEMS LIMITED

(21) Appl. No.: 11/351,943

(22) Filed: Feb. 10, 2006

(30) Foreign Application Priority Data
Feb. 10, 2005 (IE) S 2005/0067

(51) Int. Cl. G06Q 40/00

(52) U.S. Cl. 705/35

(57) ABSTRACT

A system and method for outputting hypothetical investment defining data (411) are provided by the present invention. The system comprises a plurality of networked terminals (101 to 104), each of which is configured with at least processing means (208), memory means (209), networking means (211, 212) and visual display means (202). The memory means (209) stores at least a local instantiation (409) of a network-distributable, updateable data structure and instructions (403), which configure the processing means of at least one terminal to obtain (304) financial data (410) from at least another one of the networked terminals (103) by means of the networking means (212). The local data structure instantiation (409) is updated (501) with the financial data (410) obtained. Data in the data structure instantiation (409) is processed with a plurality of data processing functions (404 to 407), wherein the data processing functions define a systemic financial data process (502 to 507). Processed systemic data (411) is output (306) to the visual display means (202) or to another of the networked terminals (104), as hypothetical investment defining data and the local instantiation (409) is either removed from the memory means or further remote financial data (410) is requested.

### FIELD OF THE INVENTION

This invention relates to systems for analysing financial data and, more particularly, to a system and method for outputting hypothetical systemic investment data from a plurality of financial data processing functions.

### BACKGROUND TO THE INVENTION

Numerous systems exist with which to attempt to forecast investment variables. Research and development is particularly extensive in this field, which aims to determine an optimum process for constructing and managing investment portfolios, because investing is a complicated process, the dynamic of which is generated by the interaction of institutions, companies and people who produce, distribute and apply financial knowledge. In other words, it is a systemic process. One element by itself—such as currency price—will not provide judicious investment data. On the contrary, the investment process requires a large variety of other supporting elements such as price, interest rate, implied option volatility, and financial futures data etc. in order to accurately forecast investment data, including for instance price movements, market risk, market correlation and investment portfolio allocation.

In the particular context of managing currency hedge funds, the investments of which are independent from more traditional investments such as stocks, bonds and property markets for which numerous portfolio construction processes are know, a major problem is the volatility of the investment markets in which currency purchases and sales, i.e. trades, are placed, best expressed as a fluctuation of currency prices and interest rate yields over a variety of time frames. Such a volatility is usually more severe in currency markets than in said other traditional markets, making the portfolio construction process more difficult in terms of determining an optimal allocation of trades for any given investment portfolio, and also making the timing of trades more significant.

Currency investment portfolios are known to range between $5,000 and $30 m or more in value, and a second problem is that owners of smaller portfolios may be disadvantaged with a lower trading priority because purchasing smaller amounts of currencies, which is compounded if the mix of portfolios of their currency hedge fund management company comprises a disproportionately high number of large portfolios.

Moreover, another problem stems from the inherent difficulty in modeling trades and market conditions, e.g. generating hypothetical investment data, for formulating investment strategies in the highly-volatile and time-sensitive context described above.

### OBJECT OF THE INVENTION

It is therefore desirable to improve financial data processing for outputting hypothetical investment data, wherein said investment data may be output as a sequence of test trades or may define said sequence of test trades independently of the trading volume defined by said investment data. It is also preferable that said hypothetical investment data be systemic, i.e. that each such test trade may be output as an optimum construct of a portfolio in respect of a plurality of factors including market forecast, market risk and investor risk.

### SUMMARY OF THE INVENTION

According to an aspect of the present invention, a system is provided for outputting hypothetical investment defining data, comprising a plurality of networked terminals, each of which is configured with at least processing means, memory means, networking means and visual display means, said memory means storing at least a local instantiation of a network-distributable, updateable data structure and instructions which configure said processing means of at least one of said terminals to obtain financial data from at least another one of said networked terminals by means of said networking means; update said local data structure instantiation with said obtained financial data; process said data in said data structure instantiation with a plurality of data processing functions, wherein said data processing functions collectively define a systemic financial data processing application; output said systemic data to said visual display means as hypothetical investment defining data and either remove said local instantiation from said memory means or request further remote financial data.

According to another aspect of the present invention, A method for outputting hypothetical investment defining data is provided, said method comprising the steps of obtaining financial data from a networked terminal; locally updating a data structure instantiation with said obtained financial data; locally processing said data in said data structure instantiation with a plurality of data processing functions, wherein said data processing functions collectively define a systemic financial data processing application; outputting said systemic data as hypothetical investment defining data and either removing deleting said systemic data or requesting further financial data.

According to yet another aspect of the present invention, a computer programmed to output hypothetical investment defining data is provided, which comprises processing means, memory means, networking means and visual display means, said memory means storing at least a local instantiation of a remote data structure and instructions which configure said processing means to obtain financial data from at least another networked terminal by means of said networking means; update said local data structure instantiation with said obtained financial data; process said data in said data structure instantiation with a plurality of data processing functions, wherein said plurality of data processing functions collectively define a systemic financial data processing application; output said systemic data to said visual display means as hypothetical investment defining data and either remove said local instantiation from said memory means or request further remote financial data.

The financial data preferably includes at least one currency price and at least one interest rate yield and the data structure is preferably a local instantiation of a remote database storing data therein as historical series.

The data processing functions preferably include a market forecasting function, a market risk forecasting function, a portfolio risk forecasting function and a broadcasting function. The market forecasting function advantageously outputs an optimal combination of expected currency price, expected interest rate yield and time fame. Alternatively, the market risk forecasting outputs volatility data.

The portfolio risk forecasting function preferably outputs hypothetical investment-defining data when the correlation between pairs of currencies is negative.

### BRIEF DESCRIPTION OF THE DRAWINGS

The features and advantages of the invention will be presented in conjunction with the following illustrations listed below:

FIG. 1 shows a preferred embodiment of the present invention in an environment, including distributed financial data sources and at least one networked terminal;

FIG. 2 provides an example of the networked terminal shown in FIG. 1, which includes processing means, memory means and networking means;

FIG. 3 details the operational steps according to which the networked terminal shown FIGS. 1 and 2 processes data, including a step of loading a set of instructions and a step of processing financial data;

FIG. 4 illustrates the contents of the memory means shown in FIG. 2 further to completing the loading step shown in FIG. 3, including a local copy of a data structure and a plurality of modules;

FIG. 5 further details the step of processing financial data shown in FIGS. 1, 3 and 4, including steps of processing financial data with a plurality of modules shown in FIG. 4;

FIG. 6 further details the step of outputting market forecast data shown in FIG. 5;

FIG. 7 further details the step of outputting market risk data shown in FIG. 5;

FIG. 8 further details the step of outputting trading risk data shown in FIG. 5; and

FIG. 9 further details the step of outputting hypothetical investment data shown in FIG. 5.

### DETAILED DESCRIPTION OF THE DRAWINGS

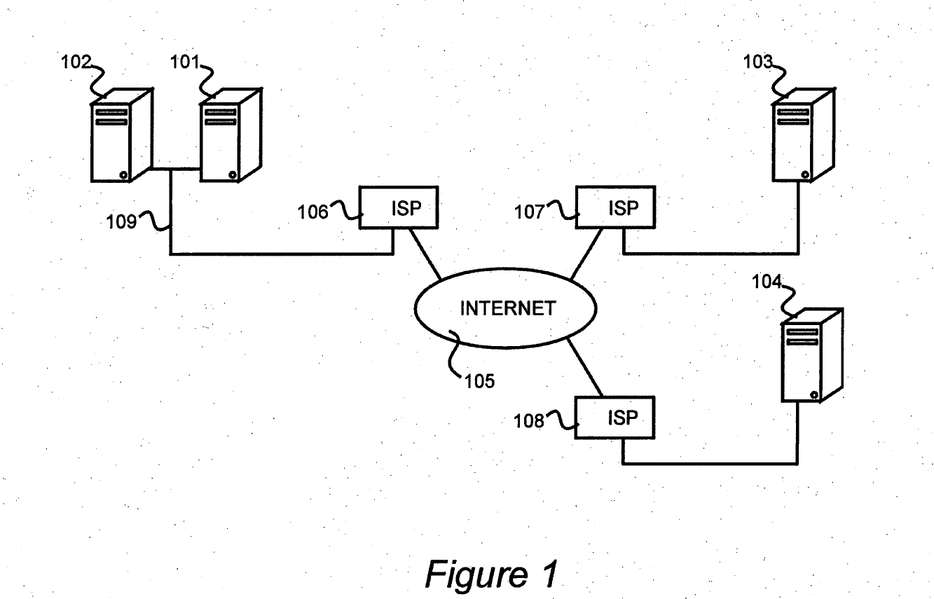

A preferred embodiment of the present invention is shown in an environment in FIG. 1, which includes a plurality of network-connected terminals 101, 102, 103 and 104. Each of said terminals is configured with data processing means, data storage means, data output means such as video display units and networking means and data input means such as said networking means and user input means, respective examples of which will be further described hereinbelow.

In the example, terminals 101 and 102 are located at a hedge fund management company such as ACM, based in Dublin, Republic of Ireland. Terminal 103 is remotely located at a real-time financial data service provider, such as the REUTERS Trading Systems Division of REUTERS, based in New York, New Jersey, USA. Terminal 104 is remotely located at a financial trading company, for instance another branch of ACM located elsewhere. Each of terminals 101, 103 and 104 are preferably network-connected to a Wide Area Network (WAN) 105, such as the Internet, via their respective Internet Service Providers (ISPs) 106, 107 and 108. Terminals 101 and 102 are also network-connected to a Local Area Network (LAN) 109 located at said hedge fund management company. In the preferred embodiment of the present invention, terminal 101 receives real-time financial data from terminal 103 over a first WAN connection, which is preferably secured with using standard 128-bit SSL encryption, which both encrypts and decrypts said financial data exchanged between said terminals over said network 105. In the preferred embodiment of the present invention still, terminal 101 broadcasts investment trading data to terminal 104 over a second WAN connection, which is also preferably secured with using said standard 128-bit SSL encryption as described above.

It will be readily apparent to those skilled in the art that the above environment is provided by way of example only, and that the present invention may be embodied in any network comprising devices connected thereto, exchanging data processed as further described hereinbelow

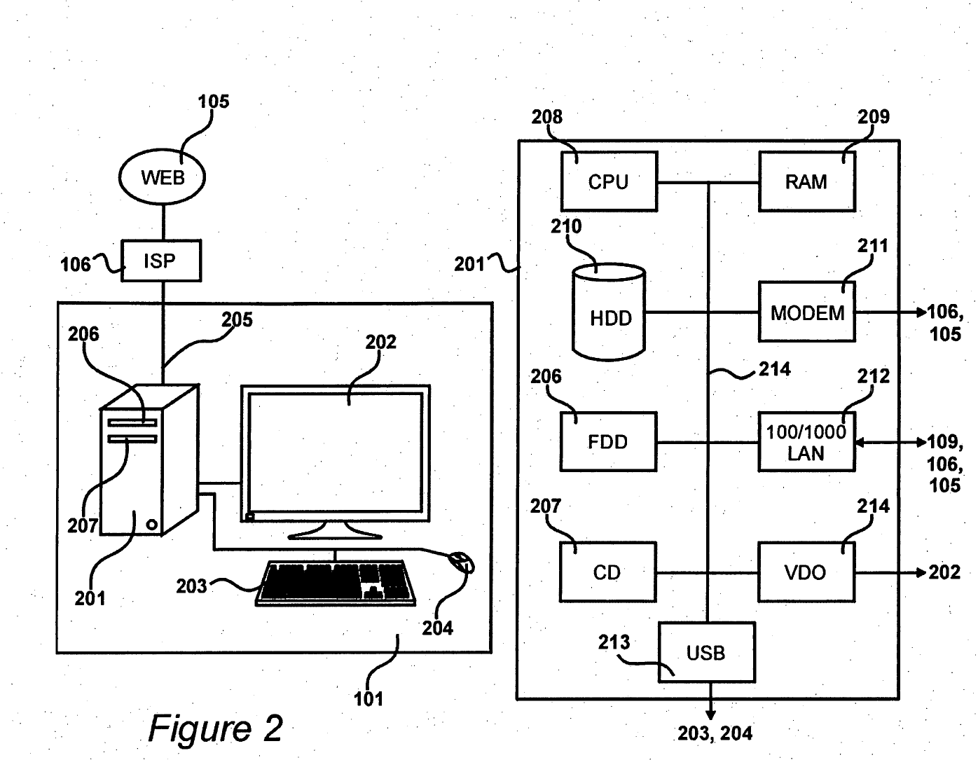

An example of the terminal 101 shown in FIG. 1 is provided in FIG. 2. Terminal 101 is a computer terminal configured with a data processing unit 201, data outputting means such as video display unit (VDU) 202, data inputting means such as a keyboard 203 and a pointing device (mouse) 204 and data inputting/outputting means such as a network connection 205, magnetic data-carrying medium reader/writer 206 and optical data-carrying medium reader/writer 207.

Within data processing unit 201, a central processing unit (CPU) 208, such as an Intel Pentium 4 manufactured by the Intel Corporation, provides task co-ordination and data processing functionality. Instructions and data for the CPU 208 are stored in main memory 209 and a hard disk storage unit 210 facilitates non-volatile storage of data and data processing instructions. A modem 211 provides a wired connection 205 to the ISP 106 or said wired connection 205 to the Internet may be performed through Local Area Network (LAN) via a network card 212, particularly if said connection is of the type known as broadband. In a preferred embodiment of the present invention, said network card 212 is further configured with wireless data distributing means, for instance to establish a wireless network connection of the type known as Wi-Fi (IEEE 802.11 protocol) with other proximate devices having similar networking means, for instance terminal 102. A universal serial bus (USB) input/output interface 213 facilitates connection to the keyboard and pointing device 203, 204. All of the above devices are connected to a data input/output bus 214, to which said magnetic data-carrying medium reader/writer 206 and optical data-carrying medium reader/writer 207 are also connected. A video adapter 215 receives CPU instructions over said bus 214 for outputting processed data to VDU 202 and/or to further output data display means.

In the preferred embodiment, data processing unit 201 is of the type generally known as a compatible Personal Computer (‘PC’ ), but may equally be any device configured with data inputting, data processing, data outputting and networking means providing at least the functionality described above. Any such device may include, but is not limited to, PowerMac® or iMac® computers manufactured by the Apple® Corporation of Cupertino, Calif., USA; a Portable Digital Assistant (PDA) such as a Palm m505® manufactured by PalmOne® Inc. of Milpitas, Calif., USA; a Portable Digital Computer (PDC) such as an IPAQ® manufactured by the Hewlett-Packard® Company of Palo Alto, Calif., USA; or even a mobile phone such as a Nokia 9500 manufactured by the Nokia® Group in Finland, all of which are generally configured with processing means, output data display means, memory means, input means and wired or wireless network connectivity.

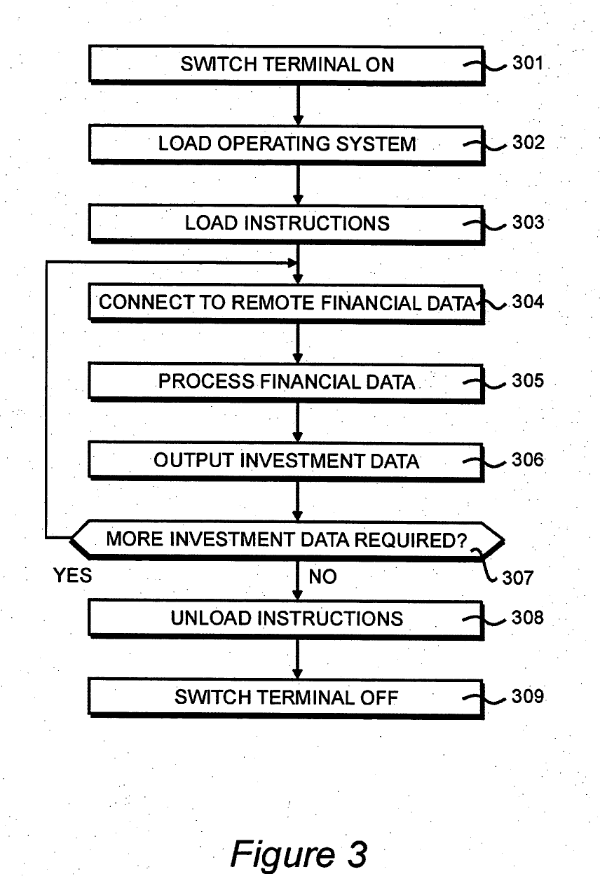

Processing steps are described in FIG. 3 according to which terminal 101 operates. Terminal 101 is first switched on at step 301. At step 302, the operating system is loaded which provides said terminal 101 with basic functionality, such as initialisation of data input and/or output devices, data file browsing, keyboard and/or mouse input processing, video data outputting, network connectivity and network data processing. At step 303, a set of financial data processing instructions is loaded into memory 209, which is a set of instructions for configuring CPU 208 to process financial data according to rules described hereafter. At step 304, terminal 101 connects to both terminal 103 and terminal 104 over WAN 105 by way of network card 212 and accesses data respectively stored thereat in real-time. In the example, terminal 103 is configured according to the TRIARCH™ application and data distribution structure of REUTERS, which is well known to those skilled in the art and provides financial data. In the example still, terminal 104 is configured substantially like terminal 101 and stores a database of the financial data of terminal 103 organised in historical series. Said financial data and a copy of the database thereof are preferably downloaded locally and stored in memory 209. Said data is subsequently processed at step 305 according to said set of instructions loaded at said step 303, such that hypothetical investment data may be output by said set of instructions according to the present invention at step 306.

Said hypothetical investment data is output at said step 306 to VDU 202 for consideration by the user of terminal 101. A question is asked at step 307, as to whether additional input financial data is required, for instance if hypothetical data output at step 306 does not satisfy conditions set by the user in terms of return on investment, risk position and/or the like, or if hypothetical data output at step 306 is insufficient to formulate an optimum investment strategy, or if local financial data previously downloaded according to step 304 and stored in memory 209 is out-of-date to re-formulate an optimum investment strategy. If the question of step 307 is answered positively, control returns to step 304, where financial data having been updated in real-time during the processing of steps 305 and 306 may therefore be downloaded, to ensure the processing of step 305 at terminal 101 uses up-to-date financial data parameters to output optimum hypothetical investment data, e.g. reduces the hypothetical character of the investment data output after downloading the updated financial data further to answering question 307 positively. The local copy of the data structure is not however downloaded again at said second iteration of step 304, in order to avoid discrepancies in the hypothetical investment data arising from data locally input by the user of terminal 101. In an alternative embodiment of the present invention, the question of step 307 is periodically answered positively regardless of the example conditions described above, to ensure up-to-date financial data is processed at terminal 101 to output optimum hypothetical investment data at any particular point in time whilst the systemic application 403 is processed by CPU 208.

Alternatively, the question of steps 307 may be answered negatively, and the functionality of the set of instructions loaded at the previous step 303 may not be required anymore, whereby said set of instructions is unloaded from memory 209 at step 308, along with the copy of the database downloaded from terminal 104. Terminal 101 may eventually be switched off at final step 309.

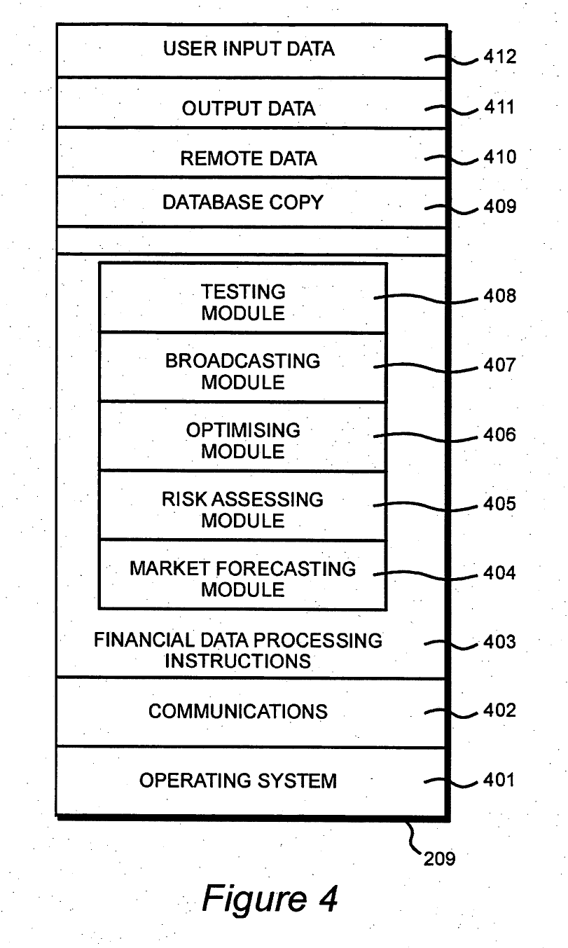

The contents of the memory 209 are illustrated in FIG. 4, further to completing the instructions loading step 303. An operating system is shown at 401 which, in the example, is Windows XP Corporate Edition manufactured and distributed by the Microsoft Corporation of Redmond, Calif., USA. Said operating system configures CPU 208 to address data input from and broadcast to local devices connected to bus 214 according to a data file and memory addressing system, as well as provide processing instructions to said devices according to device drivers. Accordingly, communication instructions are shown at 402, which represent a portion of the functionality of OS 401 dedicated to receiving and broadcasting data respectively from and to remote data processing systems such as terminals 102 to 104 via modem 211 or NIC 212, including a Secure Socket Layer (SSL) encryption module (not shown) to secure any such data distribution, and according to particular data exchange protocols such as TCP/IP. It will be readily apparent to those skilled in the art that the above OS is provided by way of example only, and that the present invention may be embodied with any of the previously-enumerated data processing devices, having respective operating systems that may differ from the example above, such as Mac OS-X in the case of a computer manufactured by Apple®, or Windows Mobile 2003 in the case of a PDC manufactured by Hewlett-Packard® or a mobile phone manufactured by Nokia®.

In the preferred embodiment of the present invention, the set of financial data processing instructions loaded at step 303 is shown at 403 and includes a plurality of respective financial data processing functions, which collectively define a systemic financial data processing application 403. Said functions include a market forecasting module 404, a market risk assessing module 405, a portfolio risk assessing module 406 and a hypothetical investment data outputting module 407, each of which will be described in further details hereinbelow. Financial data processed by application 403 includes downloaded data stored in a copy 409 of the data structure stored at terminal 104. Financial data processed by application 403 also includes remote real-time financial data 410 downloaded from TRIARCH™ terminal 103 and local hypothetical investment data 411 output by application 403. Memory 209 also includes user input data 412, which may be alphanumerical data input by means of keystrokes on keyboard 203, user interrupts input by means of clicking user-operable switches of mouse 204 and graphical user interface updates input by means of said user translating mouse 204.

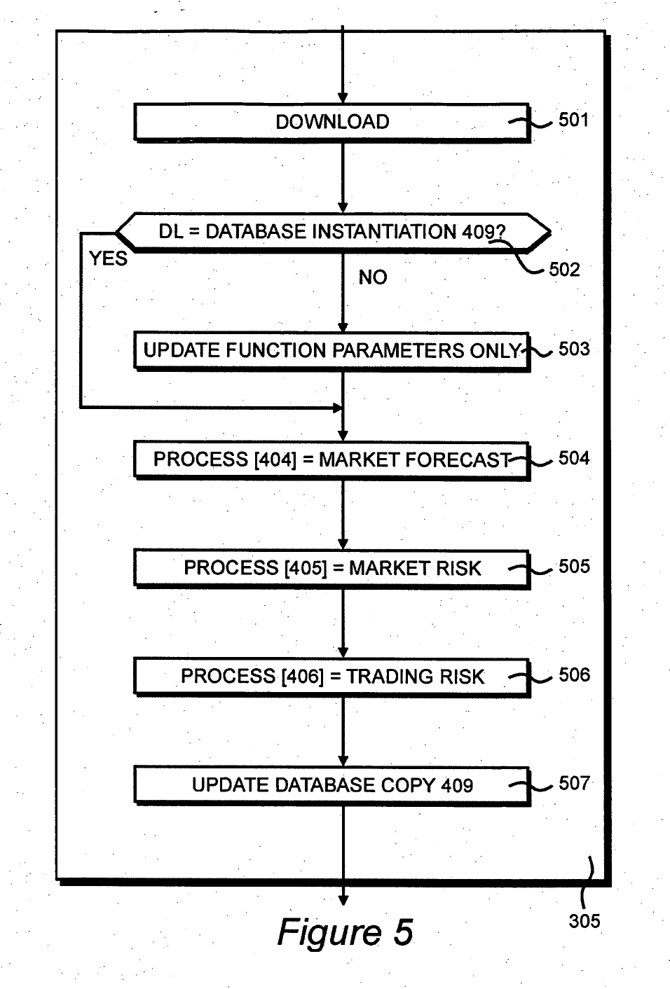

The step 305 of processing financial data 409, 410 with a plurality of modules 404 to 407 is further detailed in FIG. 5. At step 501, application 403 firstly reads the remote data 410 input from remote terminals 103 and/or 104, which includes the database copy 409 and up-to-date financial data 410 at the first iteration of step 304, then update financial data 410 at subsequent iterations of step 304. Database copy 409 is a copy of the data structure storing and referencing financial data 410 downloaded over time at terminal 104 as historical series thereof, wherein said financial data 410 respectively includes prices of currencies and yields of interest rates.

At step 502, a question is asked as to whether the data within the database copy 409 should be updated, i.e. when input network data 410 only comprises update financial data. In the preferred embodiment of the present invention, the question of step 502 is only ever answered negatively once, that is when the question of step 502 is asked for the first time subsequently to loading and starting the processing of application 403 according to step 303. When the question of step 502 is answered positively, whether upon user request according to the preferred embodiment of the present invention or automatically in an alternative embodiment, application 403 replaces any financial data stored in memory 209 with corresponding, updated financial data 410 at step 503, to the exclusion of any other data stored in local database copy 209.

At step 504, application 403 invokes the functionality of market forecasting module 404 to process historical currency and yield data in database copy 409 in order to output market forecast data defining price movements in the currency and bond markets, under the form of specific values at a specific date. Said market forecast data output at step 504 forms first input data for the processing of systemic investment data. At step 505, application 403 invokes the functionality of market risk assessing module 405 to process historical currency and yield volatility data in database copy 409 in order to output market risk data for each individual market, under the form of a confidence interval. Said confidence interval defines the likelihood of a one standard deviation move (see graph 1 below).

[image]

Using the Normal Distribution, the first confidence interval is at 68%, the second at 95%. Treasury operations in banking, for example, use this curve to assess how susceptible to a loss they are with the current open positions. Said market risk data output at step 505 therefore forms second input data for the processing of systemic investment data. At step 506, application 403 invokes the functionality of portfolio risk assessing module 406 to process database copy 409 and first and second input data respectively output from steps 504 and 505 in order to output trading risk data for each individual test investment or test trade of a portfolio or a plurality thereof, and adjust said hypothetical portfolio investments accordingly. Said trading risk data output at step 506 forms third input data for the processing of systemic investment data. Application 403 next invokes the functionality of outputting module 407 at step 507 to process database copy 409 and first, second and third input data respectively output from steps 504, 505 and 506 in order to output optimal hypothetical investment data defining trades that may be effected in one or a plurality of markets at particular points in time or price conditions.

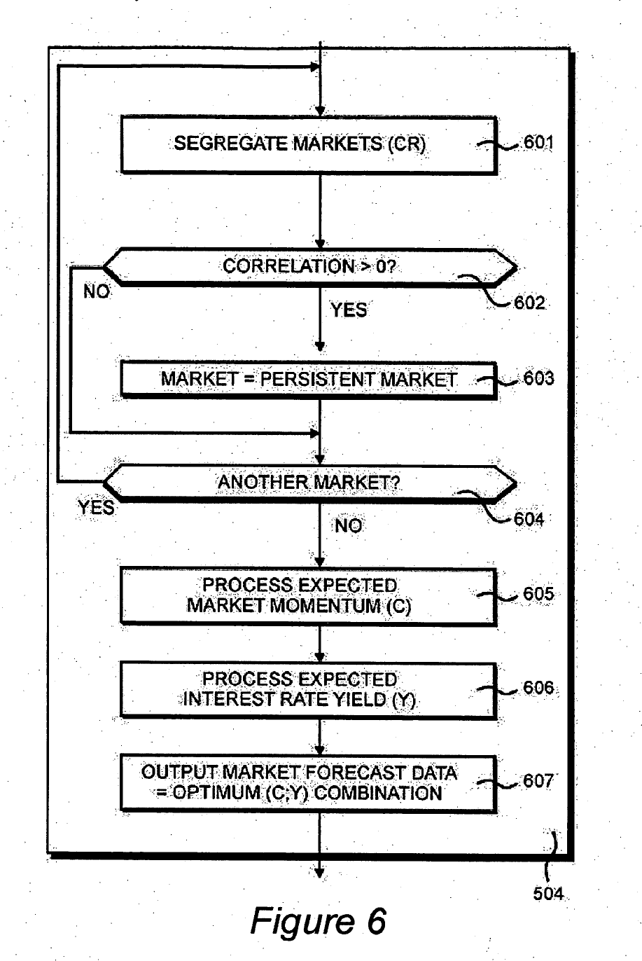

The step 504 of processing financial data 409 by Market Forecasting Module (MFM) 404 to output market forecast data is further detailed in FIG. 6. The inputs to the MFM 404 are stored in database copy 409 by downloading live real-time data 410 from Reuters via a TRIARCH™ structure 103. Once stored in the database copy 409, the module 404 uses this historical data 409 to forecast future price movements. There are two data components 410 stored (501), price and interest rate yields. The data inputs are periodically and/or manually downloaded and the forecast will be calculated independently from previous days. Markets are preferably first segregated into certain types of behavioral groups at step 601, which processes a correlation (CR) and divides markets into three distinct groups: Persistent, Random and Anti-persistent. Persistent markets exhibit serial correlation with the memory function positively correlated to historical values in the time series, whereby a question at step 602 is answered positively and any such Persistent market is declared as such at step 603 for further data processing. Conversely, Random markets display no memory feature of any nature and Anti-persistent markets exhibit serial correlation with the memory function negatively correlated to historical values in the time series, neither of Random or Anti-persistent markets warranting further processing for outputting investment data therein. The MFM 404 thus determines (602, 603, 604) the behavioral characteristics of each market to determine which markets can be defined as persistent at said step 603. In the preferred embodiment of the present invention, application 403 replaces steps 601 to 604 in daily use with a step (not shown) of looking up previously-determined persistent markets from database copy 409, thereby further accelerating the processing of step 305.

Within these persistent markets, an exponential weighed average of the historical price data is processed at step 605 to determine the expected momentum (C) of each individual currency market. The expected interest rate yield (Y) in each market is then forecasted at step 606 by extrapolating yields over multiple time frames. At the final step 607, the forecasting period is determined: using historical data 409, the MFM 404 determines the current market outlook and the cost associated with each time frame. The MFM 404 assesses relative strengths of each component to determine the optimal combination between momentum, yield and timeframes, whereby market forecast data (C; Y) is output at said step 607.

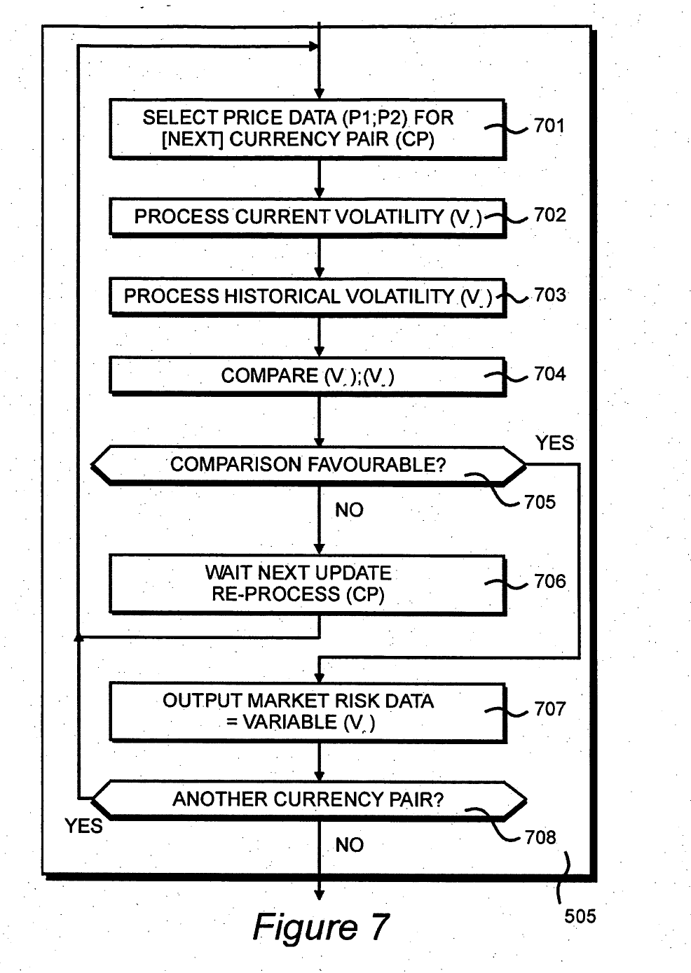

The step 505 of processing financial data 409 by Risk Assessing Module (RAM) 405 to output market risk data is further detailed in FIG. 7. The systemic investment process of the present invention defines how much risk a portfolio will theoretically take prior to placing any trades in the market. This requires a forecast of what risk is to be expected both at a portfolio level and at within each individual market. Risk in the financial markets is often defined by the Value At Risk (VAR) of a portfolio. This defines how much money is at a risk of loss at any point in time in terms of confidence intervals, as previously described. In order to measure the VAR, a forecast of the expected volatility of each component of the portfolio is required. Such forecasts typically rely on implied volatilities used in the Option Markets to forecast volatility. This can lead to problems in complex cross-currency pairs, where the relationship between volatility and correlation breaks down. The correlation matrix between currency pairs is often not positive definite. This can lead to expected correlations being outside the correlation range −1 to +1. Thus, it is difficult or even impossible to use implied volatilities to accurately forecast risk for each currency pair.

The RAM 405 forecasts the risk within each individual market while the Optimising Module 406 further described hereinbelow manages portfolio risk. At step 701, RAM 405 selects the respective price data (P1, P2) in database copy 409 of a first currency pair (CPₙ). RAM 405 processes forecast price volatility data (V_{C}) for said pair (CPₙ) at step 702. RAM 405 processes historical price volatility data (V_{H}) over a time interval or frame (T) for said pair (CPₙ) at step 703.

A comparison of forecast and historical volatility data sets (V_{C}) and (V_{H}) is subsequently processed at step 704, whereby a question is asked at step 705, as to whether the forecast price volatility data (V_{C}) exceeds historical price volatility data (V_{H}) by an empirical safety margin, signifying that there may be artifacts in the most recent set of downloaded data 410, whether as a result of unexpected or transitional market trades, or as a result of data error. If the question of step 705 is answered positively, RAM 405 elects to wait for the next database update at step 706, e.g. wait to process the next set of downloaded data 410, which may erase some or most of the statistical ‘noise’ caused by said unexpected or transitional market trades, or data error. At said step 706, the currently-selected currency pair (CPₙ) is therefore marked for subsequent re-processing according to steps 701 to 705 and control proceeds to returns to step 701, at which a next currency pair (CPₙ₊₁) may be selected and risk-assessed, and so on and so forth until said first-selected currency pair (CPₙ) is eventually processed again. Alternatively, if the question of step 705 is answered negatively, RAM 405 outputs market risk data (V_{C}) for the selected currency pair (CPₙ) at step 707 and a second question is asked at step 708, which is also asked after step 706, as to whether another currency pair exists in the database copy 409, which should be processed according to steps 701 to 708. If the question of step 708 is answered positively, control return to step 701, at which said next currency pair (CPₙ₊₁) may be selected and risk-assessed, and so on and so forth. Preferably, the processing loop defined by steps 701 to 708 of module 405 is continuous and only ever interrupted with answering the question of step 708 negatively if the user of terminal 101 wants to terminate the application 403 according to steps 308 and 309.

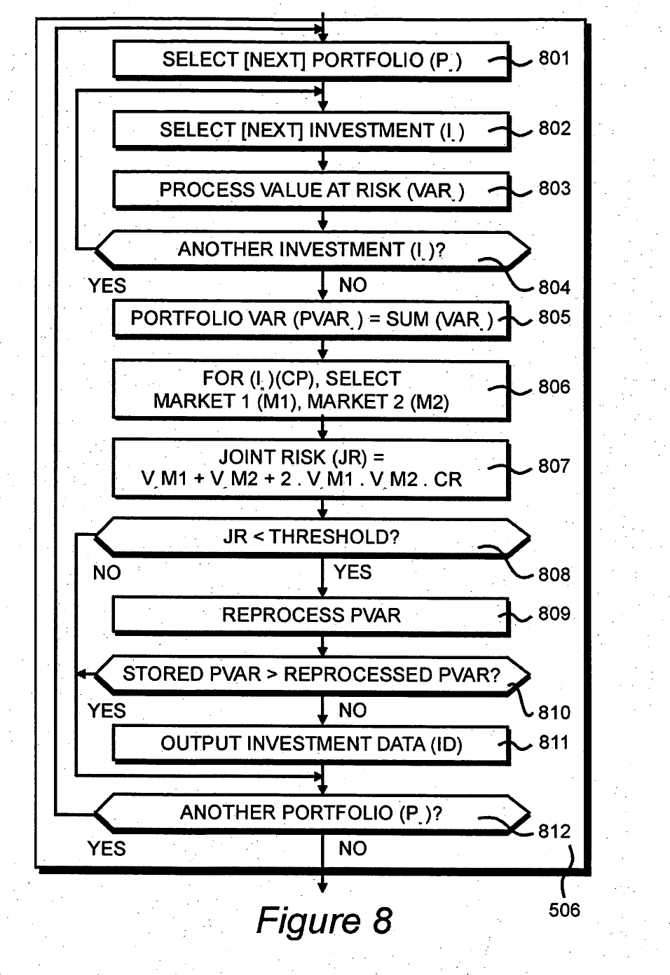

The step 506 of processing financial data 409 and data respectively output by modules 404 and 405 by portfolio risk assessing module (OM) 406 to output trading risk data is further detailed in FIG. 8. The OM 406 systematically reconstructs each portfolio (P) of investments (I) stored in database copy 409 on a daily basis or more frequently if required. A first portfolio (P_{N}) is therefore selected at step 801 and a first investment (I_{N}) thereof selected at step 802. OM 406 processes the Value-At-Risk (VARₙ) of said selected investment (I_{N}) at step 803 and a question is asked at step 804, as to whether portfolio (P_{N}) includes another investment (I_{N+1}). If the question of step 804 is answered positively, control returns to step 802 and said next investment (I_{N+1}) is selected for processing of its respective Value-At-Risk (VAR_{N+1}), and so and so forth until such time as all investments (I_{N}) of portfolio (P_{N}) have been processed and OM 406 may calculate the total Value-At-Risk (PVAR_{N}) of said portfolio (P_{N}) prior to establishing any new investment positions at step 805.

OM 406 then establishes the optimal set of hypothetical investment trades (ID) for the day using the inputs from the MFM and RAM modules 404 and 405 and adjusts the investments within the portfolio to achieve the desired asset allocation and position size. For each test investment (I_{N}) of the currently-selected portfolio (P_{N}), OM 406 identifies markets (M1, M2) respectively corresponding to the investment currency pair (CP) at step 806. To output hypothetical investment data (ID) for a portfolio which optimizes the expected return using the volatility forecast (V_{C}) for each market requires examining the correlation between each of said markets (M1, M2). Negatively correlated markets will reduce the overall risk of the investments while positively correlated markets will increase the overall risk. A relationship between the joint risk and the two markets is therefore processed as a factor (JR) at step 807. As the joint risk is reduced if the correlation between the currency pairs is negative, it is preferable to construct a portfolio that takes advantage of any negatively correlated trades, whereby (JR) is subsequently compared against an empirical threshold, shown as a question at step 808.

If the question of step 808 is answered positively, signifying that (JR) is below said empirical threshold and that the correlation is negative, OM 406 preferably recalculates the risk of investment (I_{N}) at minimum and the (VAR_{N}) of said investment (I_{N}) is recalculated at step 809, whereby a question is asked at step 810, as to whether said recalculated (VAR_{N}) compares favorably with the (VAR_{N}) of said investment (I_{N}) output at the previous step 803. If the question of step 810 is answered positively, OM 406 outputs data (ID) defining an investment or trade at step 811 and control proceeds to a final question at step 812, as to whether another portfolio (PN₊₁) of investments (I_{N}) stored in database copy 409 should be processed according to steps 801 to 812. Incidentally, if either of the question of step 808 or the question of step 810 are respectively answered negatively, control proceeds directly to the question of step 812. Preferably, the processing loop defined by steps 801 to 812 of module 406 is continuous and only ever interrupted with answering question 812 positively if the user of terminal 101 wants to terminate the application 403 according to steps 308 and 309. Risk-assessed and forecast investment data (ID) is therefore output by portfolio risk assessing module 406 to maintain one or a plurality of portfolios of investments, wherein any investment positions that exceed the expected volatility forecast (V_{C}) are continually adjusted to reflect the new market conditions.

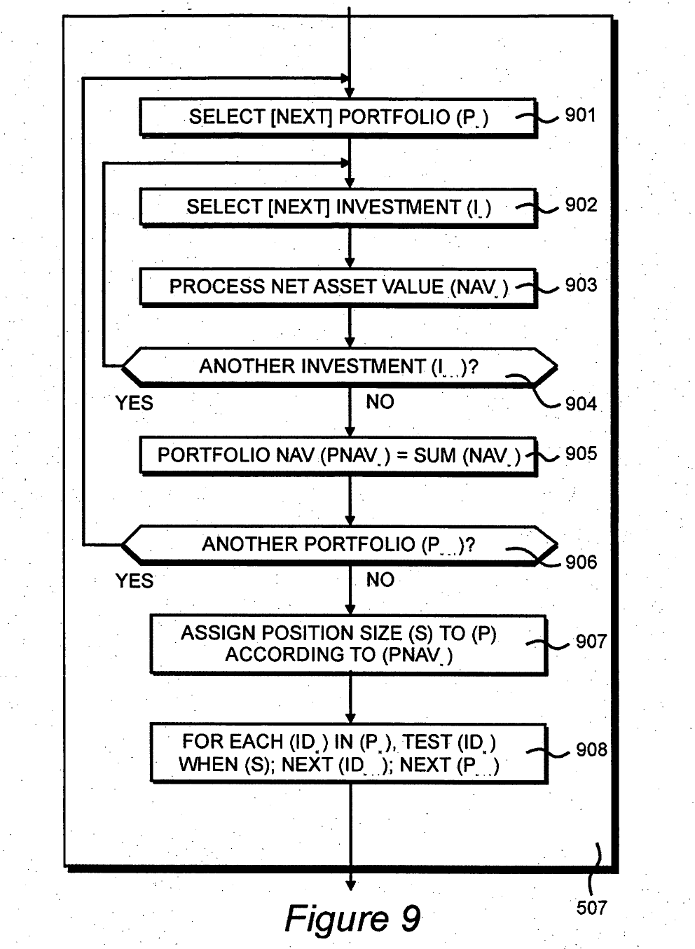

The step 507 of outputting hypothetical investment data 411 by hypothetical investment data outputting module, which may also be referred to as broadcasting module (BM) 407, is further detailed in FIG. 9. BM 407 allows the test trades (ID) to be mock-placed in one or a plurality of markets in an efficient manner. The speed at which the test trades can be placed is essential to the performance of the hypothetical investments in either of the short and long terms. BM 407 also ensures that no customer is disadvantaged because of portfolio size.

Like the OM 406, the BM 407 systematically reconstructs each portfolio (P) of investments (I) stored in database copy 409 on a daily basis or more frequently if required. A first portfolio (P_{N}) is therefore selected at step 901 and a first investment (I_{N}) thereof selected at step 902. BM 407 processes the Net Asset Value (NAV_{N}) of said selected investment (I_{N}) at step 903 and a question is asked at step 904, as to whether portfolio (P_{N}) includes another investment (I_{N+1}). If the question of step 904 is answered positively, control returns to step 902 and said next investment (I_{N+1}) is selected for processing of its respective Net Asset Value (NAV_{N+1}), and so and so forth until such time as all investments (I_{N}) of portfolio (P_{N}) have been processed and BM 407 may calculate the total Net Asset Value (NAV_{N}) of said portfolio (P_{N}) at step 905.

The BM 407 calculates the net asset value (NAV) of each account prior to trading and based on that determines what size position to enter for each account. A question is therefore asked at step 906, as to whether database copy 409 includes another portfolio (P_{N+1}). If the question of step 906 is answered positively, control returns to step 901 and said next portfolio (P_{N+1}) is selected for processing of its respective Net Asset Value (NAV_{N+1}) at step 905, and so on and so forth until such time as all portfolios (P_{N}) of database copy 409 have been processed. A position size (S) is subsequently assigned to each account (P_{N}) based upon its respective (NAV_{N}) at step 907. The BM 407 then summarizes all of the investments (I_{N}) of each portfolio (P_{N}) into a table at step 908 according to (S), wherein each hypothetical investment-defining data (ID) output by OM 406 is assigned a corresponding position size reference (S). Said table therefore defines a mock-broadcasting sequence, according to which each (ID) entry of said table (which would be sent to the communication instructions 402 for broadcast to the remote terminal of a trading organization, such as Deutsche Bank based in London, in the case of actual investment-defining data) is time-logged, thus allowing one trade (ID) to be executed with its particular market at one price (S) and, further, allowing the user of terminal 101 to observe the results the hypothetical investment data output using actual financial data would have upon portfolio data within database copy 409, if said hypothetical investment data were to be used for actual portfolio investment data.

1. A system for outputting hypothetical investment defining data, comprising a plurality of networked terminals, each of which storing at least a local copy of a network-distributable, updateable data structure, wherein at least one of said terminals is configured to perform the steps of
obtaining financial data from at least another one of said networked terminals;
updating said local data structure with said obtained financial data;
processing said data in said data structure with a plurality of data processing modules, wherein said data processing modules collectively define a systemic financial data processing application;
outputting said processed data to visual display means; and
either deleting said local data structure or requesting further remote financial data;
wherein said processed data in said local data structure is hypothetical systemic investment defining data and requesting further remote financial data reduces the hypothetical character of said hypothetical systemic investment defining data.

2. A system according to claim 1, wherein the financial data includes at least one currency price and at least one interest rate yield.

3. A system according to claim 2, wherein the data structure is a database storing data therein as historical series.

4. A system according to claim 1, wherein said plurality of data processing modules includes a market forecasting module, a market risk assessing module, a portfolio risk assessing module and a hypothetical investment data outputting module.

5. A system according to claim 4, wherein the market forecasting module outputs an optimal combination of expected currency price, expected interest rate yield and time fame.

6. A system according to claim 4, wherein the market forecasting module outputs volatility data.

7. A system according to claim 4, wherein the portfolio risk forecasting module outputs investment-defining data when the correlation between pairs of currencies is negative.

8. A system according to claim 4, wherein the hypothetical investment data outputting module assigns a position size for market entry based upon the respective net asset value of each portfolio of investments, irrespectively of portfolio size.

9. A system according to claim 8, wherein the position size defines an investment defining data broadcasting sequence.

10. A system according to claim 1, wherein any of said terminals is a device configured with data inputting, data processing, data outputting and networking means, such as a compatible Personal Computer (‘PC’), a Portable Digital Assistant (‘PDA’), a Portable Digital Computer (‘PDC’) or a mobile telephone handset.

11. A method for outputting hypothetical investment defining data, said method comprising the steps of
obtaining financial data from a networked terminal;
updating a local copy of a data structure with said obtained financial data;
processing said data in said local data structure with a plurality of data processing modules, wherein said data processing modules collectively define a systemic financial data processing application;
outputting said systemic data as hypothetical investment defining data; and
either removing deleting said systemic data or requesting additional input financial data, wherein said processed data in said local data structure is hypothetical systemic investment defining data and requesting further remote financial data reduces the hypothetical character of said hypothetical systemic investment defining data

12. A method according to claim 11, wherein the financial data includes at least one currency price and at least one interest rate yield.

13. A method according to claim 12, wherein the data structure is a database storing data therein as historical series.

14. A method according to claim 11, wherein said plurality of data processing modules includes a market forecasting module, a market risk assessing module, a portfolio risk assessing module and a hypothetical investment data outputting module.

15. A method according to claim 11, further including the step of obtaining additional input financial data if hypothetical systemic investment defining data output does not satisfy conditions set for return on investment or investment risk position.

16. A method according to claim 11, further including the step of obtaining additional input financial data if hypothetical systemic investment defining data output is insufficient to formulate an optimum investment strategy.

17. A method according to claim 11, further including the step of obtaining additional input financial data if local financial data previously obtained is out-of-date to re-formulate an optimum investment strategy.

18. A method according to claim 11, wherein said additional input financial data is updated in real-time at said at least another one of said networked terminals for obtaining up-to-date financial data parameters to output optimum hypothetical methodic investment defining data.

19. A method according to any of claims 11, wherein said networked terminal is a device configured with data inputting, data processing, data outputting and networking means, such as a compatible Personal Computer (‘PC’), a Portable Digital Assistant (‘PDA’), a Portable Digital Computer (‘PDC’) or a mobile telephone handset.

20. A computer programmed to output hypothetical investment defining data, comprising processing means, memory means, networking means and visual display means, said memory means storing at least a local copy of a remote data structure and instructions which configure said processing means to
obtain financial data from at least another networked terminal by means of said networking means;
update said local data structure with said obtained financial data;
process said data in said data structure with a plurality of data processing functions, wherein said plurality of data processing functions collectively define a systemic financial data processing application;
output said systemic data to said visual display means as hypothetical investment defining data; and
either remove said local instantiation from said memory means or request further remote financial data, wherein said processed data in said local data structure is hypothetical systemic investment defining data and requesting further remote financial data reduces the hypothetical character of said hypothetical systemic investment defining data.

21. A computer programmed according to claim 20, wherein the financial data includes at least one currency price and at least one interest rate yield.

22. A computer programmed according to claim 21, wherein the data structure is a database storing data therein as historical series.

23. A computer programmed according to claim 22, wherein the data processing modules include a market forecasting module, a market risk forecasting module, a portfolio risk forecasting module and a broadcasting module.

24. A computer programmed according to claim 23, wherein the instructions further configure the processing means to output an optimal combination of expected currency price, expected interest rate yield and time fame.

25. A computer programmed according to claim 24, wherein the instructions further configure the processing means to assign a position size for market entry based upon the respective net asset value of each portfolio of investments, irrespectively of portfolio size.

26. A computer programmed according to claim 24, wherein said computer is any of a compatible Personal Computer (‘PC’), a Portable Digital Assistant (‘PDA’), a Portable Digital Computer (‘PDC’) or a mobile telephone handset.
